(19) United States
(12) Patent Application Publication
(10) Pub. No.: US 2010/0261092 A1
(43) Pub. Date: Oct. 14, 2010

(54) FUEL CELL

(76) Inventor: Akira YAJIMA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/821,650

(22) Filed: Jun. 23, 2010

Related U.S. Application Data
(63) Continuation of application No. PCT/JP2008/072278, filed on Dec. 8, 2008.

(30) Foreign Application Priority Data
Dec. 27, 2007 (JP) 2007-337805

(51) Int. Cl. H01M 8/10; H01M 8/02

(52) U.S. Cl. 429/483; 429/535

(57) ABSTRACT

A fuel cell includes a membrane electrode assembly includes an anode, a cathode and an electrolyte membrane interposed between the anode and the cathode, an anode conductive layer which is in contact with the anode, a cathode conductive layer which is in contact with the cathode, and a fuel supply mechanism which is disposed on the anode side of the membrane electrode assembly to supply fuel to the anode. The membrane electrode assembly includes a shape formed convexly toward the anode side in a separate condition.

### CROSS-REFERENCE TO RELATED APPLICATIONS

This is a Continuation Application of PCT Application No. PCT/JP2008/072278, filed Dec. 8, 2008, which was published under PCT Article 21(2) in Japanese.

This application is based upon and claims the benefit of priority from prior Japanese Patent Application No. 2007-337805, filed Dec. 27, 2007, the entire contents of which are incorporated herein by reference.

### BACKGROUND OF THE INVENTION

1. Field of the Invention

The present invention relates to a fuel cell, and particularly to a fuel cell using liquid fuel.

2. Description of the Related Art

Recently, there have been attempts to use fuel cells for the power sources of various types of portable electronic devices such as notebook-type personal computers and mobile telephones, thereby making it possible to use these electronic devices without charging for a long period of time. These fuel cells have the characteristics that they can generate electricity only with supply of fuel and air and can also generate electricity continuously for a long period of time only with supply of fuel. For this reason, if these fuel cells can be small-sized, they can be very advantageous systems as the power sources of portable electronic devices.

A direct methanol fuel cell (DMFC) can be miniaturized and fuel therein is easily handled. This is why the direct methanol fuel cell is expected as the promising power source for portable electronic devices.

The active system such as a gas-supply type and a liquid-supply type, and the passive type such as an internal gasification type in which liquid fuel in a fuel receiving section is vaporized inside a battery to supply the gasified fuel to a fuel electrode are known as the liquid fuel supply system in the DMFC.

As the measures taken to supply fuel to the anode, various methods may be adopted. Examples to be considered as these methods include a system in which liquid fuel such as an aqueous methanol solution is made to flow directly under the anode conductive layer, an external gasification type in which methanol or the like is gasified outside a fuel cell to generate fuel gas which is then made to flow under the anode conductive layer, and an internal gasification type in which liquid fuel such as pure methanol and an aqueous methanol solution is received in a fuel tank and gasified inside a cell to supply the gasified fuel to the anode.

Also, examples of methods to be considered as the measures taken to supply air as the oxidizer to the cathode include an active system in which air is forcibly supplied by a fan or blower and a spontaneous aspiration (passive) type in which air is supplied only by natural diffusion from the atmosphere.

Among these systems, a passive system such as an internal gasification type is particularly advantageous for miniaturization of DMFCs. In the passive type DMFCs, a structure is proposed in which a membrane electrode assembly (cells of a fuel cell) comprising a fuel electrode, an electrolyte membrane and an air electrode is disposed on a fuel receiving section constituted of a box container made of a resin (see, for example, International Publication No. 2005/112172). The membrane electrode assembly is interposed between the anode conductive layer disposed on the fuel electrode side and the cathode conductive layer disposed on the air electrode side.

Electrical connection of the membrane electrode assembly with the anode conductive layer and cathode conductive layer is usually made by plane contact between conductive materials. In order to secure this electrical contact, it is necessary for the anode conductive layer and cathode conductive layer to be pressed against the membrane electrode assembly under a predetermined pressure or more.

However, if a generating reaction is run in the membrane electrode assembly, the temperature of the membrane electrode assembly rises, so that the member constituting the fuel cell is thermally expanded or gas such as CO₂ is produced due to the generating reaction, which increases the pressure in the fuel cell, bringing about a reduction in pressure applied in the direction of thickness of the membrane electrode assembly, and there is therefore the case where the contact resistance between the membrane electrode assembly and the anode conductive layer or cathode conductive layer is increased. When the contact resistance between the membrane electrode assembly and the anode conductive layer or cathode conductive layer is increased in this manner, the power obtained from the fuel cell is resultantly dropped because of Ohms loss.

In order to prevent the reduction in power as mentioned above, a method has been carried out in which the thickness and strength of the member constituting the fuel cell are increased to make the member resistant to deformation even if the member is thermally expanded or the pressure of gas is increased, thereby minimizing the reduction in pressure under which the membrane electrode assembly is pressed in the direction of its thickness. However, if such a measure is taken, there is the case where the weight and volume of the whole fuel cell are increased, which is not necessarily desirable to use the fuel cell as power sources of portable devices.

### BRIEF SUMMARY OF THE INVENTION

The present invention has been made in view of this situation and it is an object of the invention to provide a fuel cell which keeps the membrane electrode assembly and the conductive layer in a good contact condition and produces a high output.

A fuel cell according to a first aspect of the present invention comprises a membrane electrode assembly comprising an anode, a cathode and an electrolyte membrane interposed between the anode and the cathode, an anode conductive layer which is in contact with the anode, a cathode conductive layer which is in contact with the cathode and a fuel supply mechanism which is disposed on the anode side of the membrane electrode assembly to supply fuel to the anode, wherein the membrane electrode assembly comprises a shape formed convexly toward the anode side in a separate condition before it is incorporated into the fuel cell.

A method of producing a fuel cell according to a second aspect of the present invention comprises at least A method of producing a fuel cell, comprises at least forming an anode, forming a cathode; forming an electrolyte membrane, binding at least two or more of the anode, the cathode and the electrolyte membrane to form a membrane electrode assembly, and incorporating the membrane electrode assembly into a fuel cell comprising an anode conductive layer which is in contact with the anode, a cathode conductive layer which is in contact with the cathode and a fuel supply mechanism which is disposed on the anode side of the membrane electrode assembly to supply fuel to the anode, wherein the binding comprises pressing the membrane electrode assembly into a shape formed convexly toward the anode side.

A fuel cell according to a third aspect of the present invention comprises a membrane electrode assembly comprising an anode, a cathode and an electrolyte membrane interposed between the anode and the cathode, an anode conductive layer which is in contact with the anode, a cathode conductive layer which is in contact with the cathode, and a fuel supply mechanism which is disposed on the anode side of the membrane electrode assembly to supply fuel to the anode, wherein the membrane electrode assembly comprises a shape formed convexly toward the cathode side in a separate condition before it is incorporated into the fuel cell.

A method of producing a fuel cell according to a fourth aspect of the present invention comprises at least forming an anode, forming a cathode, forming an electrolyte membrane, binding at least two or more of the anode, the cathode and the electrolyte membrane to form a membrane electrode assembly, and incorporating the membrane electrode assembly into a fuel cell comprising an anode conductive layer which is in contact with the anode, a cathode conductive layer which is in contact with the cathode and a fuel supply mechanism which is disposed on the anode side of the membrane electrode assembly to supply fuel to the anode, wherein the binding comprises pressing the membrane electrode assembly into a shape formed convexly toward the cathode side.

### BRIEF DESCRIPTION OF THE SEVERAL VIEWS OF THE DRAWING

FIG. 1 is a schematic view showing an example of the structure of a fuel cell according to an embodiment of the present invention.

FIG. 2 is a view for explaining an example of the structure of a membrane electrode assembly of a fuel cell shown in FIG. 1.

FIG. 3 is a view for explaining an example of the shape of a membrane electrode assembly of a fuel cell according to First Example of the present invention.

FIG. 4 is a view for explaining an example of the shape of a membrane electrode assembly of a fuel cell according to Second Example of the present invention.

FIG. 5 is a view for explaining an example of the results of evaluation for fuel cells according to First Example, Second Example and Comparative Example of the present invention.

### DETAILED DESCRIPTION OF THE INVENTION

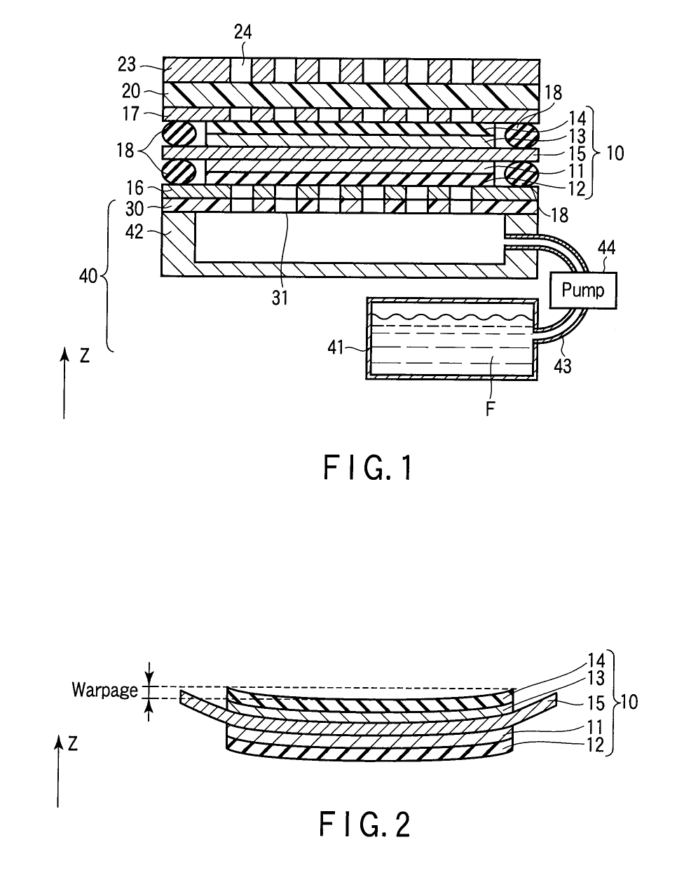

A fuel cell according to an embodiment of the present invention will be explained with reference to the drawings. As shown in FIG. 1, the fuel cell according to this embodiment comprises a membrane electrode assembly 10. The membrane electrode assembly 10 comprises an anode (fuel electrode), a cathode (air electrode) and an electrolyte membrane 15 interposed between the anode and the cathode.

The anode comprises an anode gas diffusion layer 12 and an anode catalyst layer 11 disposed on the anode gas diffusion layer 12. The cathode comprises a cathode gas diffusion layer 14 and a cathode catalyst layer 13 disposed on the cathode gas diffusion layer 14. An anode conductive layer 16 is disposed on the anode side of the membrane electrode assembly 10. A cathode conductive layer 17 is disposed on the cathode side of the membrane electrode assembly 10.

In the fuel cell according to this embodiment, the anode is produced by the following production method. First, a perfluorocarbonsulfonic acid solution is added as a proton conductive resin, and water and methoxypropanol are added as dispersants, to carbon black carrying anode catalyst particles (Pt:Ru=1:1) and the carbon black carrying anode catalyst particles is dispersed to prepare a paste.

The paste obtained in the above manner is applied to porous carbon paper (for example, a square shape of 40 mm×30 mm) to be used as the anode gas diffusion layer 12, thereby making it possible to produce the anode catalyst layer 11 having a thickness of 100 μm.

In the fuel cell according to this embodiment, the cathode is produced by the following production method. First, a perfluorocarbonsulfonic acid solution is added as a proton conductive resin, and water and methoxypropanol are added as dispersants, to carbon black carrying cathode catalyst particles (Pt) and the carbon black carrying cathode catalyst particles is dispersed to prepare a paste.

The paste obtained in the above manner is applied to porous carbon paper to be used as the cathode gas diffusion layer 14, thereby making it possible to produce the cathode catalyst layer 13 having a thickness of, for example, 100 μm.

In the fuel cell according to this embodiment, the anode gas diffusion layer 12 and the cathode gas diffusion layer 14 have almost the same shape, size and thickness. Also, the anode catalyst layer 11 and the cathode catalyst layer 13 which have been applied to these gas diffusion layers respectively have almost the same shape and size.

A perfluorocarbonsulfonic acid film (trade name: Nafion film, manufactured by Du Pont) having a thickness of 30 μm and a moisture content of 10 to 20% by weight is interposed as the electrolyte membrane 15 between the anode catalyst layer 11 and the cathode catalyst layer 13. Then, the anode catalyst layer 11 is positioned to be opposite to the cathode catalyst layer 13, after which they are subjected to hot pressing to produce the membrane electrode assembly 10 having a warped shape formed convexly toward the anode side.

In this case, the method used to make the membrane electrode assembly 10 have a warped shape formed convexly toward the anode side is not limited to the above method including the treatment using a hot press. For example, the membrane electrode assembly 10 may be made to have a warped shape formed convexly toward the anode side by forming the membrane electrode assembly 10 by using, as the anode material, a material having a higher swelling rate than the cathode material.

A difference in swelling rate between the anode and the cathode can be confirmed by the following method.

The membrane electrode assembly is taken out of the product, and a part (at least an area of 1 cm² or more) or all of the membrane electrode assembly is treated in the following manner.

When at least one or both of the anode gas diffusion layer and the cathode gas diffusion layer are formed in the membrane electrode assembly, these gas diffusion layers are peeled off. Alternatively, the side which is not a measuring subject is mechanically abraded to remove them.

Because the membrane electrode assembly from which the anode gas diffusion layer and the cathode gas diffusion layer have been peeled off and removed is in such a condition that the anode catalyst layer is stuck to one surface of the electrolyte membrane and the cathode catalyst layer is stuck to the other surface, the following treatments are carried out in this condition.

The membrane electrode assembly after the above peeling and removal treatment is allowed to stand in an environment of a temperature of 25° C. and a relative humidity of 30% for 24 hours and in an environment of a temperature of 25° C. and a relative humidity of 100% for 24 hours to compare the conditions of the both catalyst layers of the membrane electrode assembly after the above treatments.

If the shapes of the both (the direction of the warpage of the membrane electrode assembly and the degree of warpage) are the same, it may be determined that the anode catalyst layer and the cathode catalyst layer have the same swelling rate.

When the condition of the both corresponds to at least one of the following (A) to (C), it may be determined that the anode catalyst layer has a higher swelling rate than the cathode catalyst layer.

(A) The both have warped shapes formed convexly toward the anode side and the warpage of the membrane electrode assembly is larger in the environment of a relative humidity of 100% than in the environment of a relative humidity of 30%.

(B) The both have warped shapes formed convexly toward the cathode side and the warpage of the membrane electrode assembly is smaller in the environment of a relative humidity of 100% than in the environment of a relative humidity of 30%.

(C) The membrane electrode assembly has a plane shape or a warped shape formed convexly toward the cathode side after it is allowed to stand in the environment of a relative humidity of 30% and has a warped shape formed convexly toward the anode side after it is allowed to stand in the environment of a relative humidity of 100%.

When the condition of the both corresponds to at least one of the following (D) to (F), it may be determined that the cathode catalyst layer has a higher swelling rate than the anode catalyst layer.

(D) The both have warped shapes formed convexly toward the cathode side and the warpage of the membrane electrode assembly is larger in the environment of a relative humidity of 100% than in the environment of a relative humidity of 30%.

(E) The both have warped shapes formed convexly toward the anode side and the warpage of the membrane electrode assembly is smaller in the environment of a relative humidity of 100% than in the environment of a relative humidity of 30%.

(F) The membrane electrode assembly has a plane shape or a warped shape formed convexly toward the anode side after it is allowed to stand in the environment of a relative humidity of 30% and has a warped shape formed convexly toward the cathode side after it is allowed to stand in the environment of a relative humidity of 100%.

Also, the membrane electrode assembly 10 may be made to have a warped shape formed convexly toward the anode side by forming the membrane electrode assembly using, as the anode material, a material having a higher thermal expansion coefficient than the cathode material.

A difference in thermal expansion coefficient between the anode and the cathode can be confirmed by the following method. The membrane electrode assembly is taken out of the product, and a part (at least an area of 1 cm² or more) or all of the membrane electrode assembly is treated in the following manner.

When at least one or both of the anode gas diffusion layer and the cathode gas diffusion layer are formed in the membrane electrode assembly, these gas diffusion layers are peeled off. Alternatively, the side which is not a measuring subject is mechanically abraded to remove them.

Because the membrane electrode assembly from which the anode gas diffusion layer and the cathode gas diffusion layer have been peeled off and removed is in such a condition that the anode catalyst layer is stuck to one surface of the electrolyte membrane and the cathode catalyst layer is stuck to the other surface, the following treatments are carried out in this condition.

The membrane electrode assembly after the above peeling and removal treatment is allowed to stand in an environment of a temperature of 5° C. and a relative humidity of 50% for 24 hours and in an environment of a temperature of 45° C. and a relative humidity of 50% for 24 hours to compare the conditions of the both catalyst layers of the membrane electrode assembly after the above treatments.

If the shapes of the both (the direction of the warpage of the membrane electrode assembly and the degree of warpage) are the same, it may be determined that the anode catalyst layer and the cathode catalyst layer have the same thermal expansion coefficient.

When the condition of the both corresponds to at least one of the following (a) to (c), it may be determined that the anode catalyst layer has a higher thermal expansion coefficient than the cathode catalyst layer.

(a) The both have warped shapes formed convexly toward the anode side and the warpage of the membrane electrode assembly is larger in the environment of a temperature of 45° C. than in the environment of a temperature of 5° C.

(b) The both have warped shapes formed convexly toward the cathode side and the warpage of the membrane electrode assembly is smaller in the environment of a temperature of 45° C. than in the environment of a temperature of 5° C.

(c) The membrane electrode assembly has a plane shape or a warped shape formed convexly toward the cathode side after it is allowed to stand in the environment of a temperature of 5° C. and has a warped shape formed convexly toward the anode side after it is allowed to stand in the environment of a temperature of 45° C.

When the condition of the both corresponds to at least one of the following (d) to (f), it may be determined that the cathode catalyst layer has a higher thermal expansion coefficient than the anode catalyst layer.

(d) The both have warped shapes formed convexly toward the cathode side and the warpage of the membrane electrode assembly is larger in the environment of a temperature of 45° C. than in the environment of a temperature of 5° C.

(e) The both have warped shapes formed convexly toward the anode side and the warpage of the membrane electrode assembly is smaller in the environment of a temperature of 45° C. than in the environment of a temperature of 5° C.

(f) The membrane electrode assembly has a plane shape or a warped shape formed convexly toward the anode side after it is allowed to stand in the environment of a temperature of 5° C. and has a warped shape formed convexly toward the cathode side after it is allowed to stand in the environment of a temperature of 45° C.

In the case where the swelling rate or thermal expansion coefficient of the anode is designed to be higher than that of the cathode, a groove may be formed on the anode or cathode such that the membrane electrode assembly 10 tends to have a warped shape.

In the membrane electrode assembly 10 of the fuel cell according to this embodiment, a gas discharge hole (not shown) 0.5 mm in diameter may be formed in the electrolyte membrane 15 at two positions which are in contact with neither the anode catalyst layer 11 nor the cathode catalyst layer 13 and correspond to the inside of an O-ring 18 which will be explained later.

On this membrane electrode assembly 10, in succession, the anode conductive layer 16 and the cathode conductive layer 17 are disposed opposite to the anode catalyst layer 11 side on the anode gas diffusion layer 12 and opposite to the cathode catalyst layer 13 side on the cathode gas diffusion layer 14, respectively.

As the anode conductive layer 16 and the cathode conductive layer 17, a porous layer (for example, a mesh) or foil material made of metal materials such as gold and nickel, or a composite material obtained by coating a conductive metal material such as stainless steel (SUS) with a highly conductive metal such as gold may be used.

The O-rings 18 made of rubber are respectively inserted between the electrolyte membrane 15 and the anode conductive layer 16 and between the electrolyte membrane 15 and the cathode conductive layer 17 to seal the membrane electrode assembly 10.

A polyethylene porous film having a thickness of 1.0 mm, an air permeability of 2.0 sec/100 cm³ (according to the measuring method prescribed in JIS P-8117), a water-vapor permeability of 2000 g/(m²·24 h) (according to the measuring method prescribed in JIS L-1099 A-1) and a Shore hardness of D44 was cut into a rectangular shape 44 mm in length and 34 mm in width and laminated as a humidification layer 20 on the cathode conductive layer 17.

The air supplied from the atmosphere to the cathode transmits this humidification layer 20. Also, this humidification layer 20 applies adequate pressure between the membrane electrode assembly 10 having a warped shape and the cathode conductive layer 17 to also play a role in the reduction of electric contact resistance. For this reason, the Shore hardness of the humidification plate is preferably D35 or more and D55 or less.

In this case, if the Shore hardness is too low, this brings about an increase in contact resistance because the pressure applied between the membrane electrode assembly 10 and the cathode conductive layer 17 is dropped, whereas if the Shore hardness is too high, large pressure is applied only to a limited part of the membrane electrode assembly and the cathode conductive layer 17 while the pressure applied to other parts is dropped, resulting also in increased resistance.

Specifically, when the Shore hardness of the humidification layer 20 is D35 or more and D55 or less, the contact conditions between the membrane electrode assembly 10 and the cathode conductive layer 17 and between the membrane electrode assembly 10 and the anode conductive layer 16 are improved.

A 1.0-mm-thick stainless plate (SUS304) formed with 48 circular air introduction ports 24 having a diameter of 3 mm uniformly is laminated as a surface cover 23 on this humidification layer 20.

A fuel supply mechanism 40 to supply a liquid fuel F to a fuel distribution layer 30 is disposed on the anode side of the membrane electrode assembly 10. The fuel supply mechanism 40 mainly comprises, as shown in FIG. 1, a fuel receiving section 41, a fuel supply section 42 and a passage 43. The liquid fuel F corresponding to the membrane electrode assembly 10 (cells of the fuel cell) is received in the fuel receiving section 41. Examples of the liquid fuel F include methanol fuel such as aqueous methanol solutions having various concentrations and pure methanol.

Here, the liquid fuel F is not limited to methanol fuel. The liquid fuel F may be ethanol fuel such as an aqueous ethanol solution or pure ethanol, propanol fuel such as an aqueous propanol solution or pure propanol, glycol fuel such as an aqueous glycol solution or pure glycol, dimethyl ether, formic acid or other liquid fuel. In any case, liquid fuel corresponding to cells of a fuel cell is received in the fuel receiving section 41.

The fuel supply section 42 is connected to the fuel receiving section 41 through the passage 43 for the liquid fuel F, the passage 43 being constituted of a pipe or the like. The liquid fuel F is introduced into the fuel supply section 42 from the fuel receiving section 41 through the passage 43. The introduced liquid fuel F and/or gasified components of this liquid fuel F are supplied to the membrane electrode assembly 10 through the fuel distribution layer 30 and the anode conductive layer 16.

The passage 43 is not limited to the pipe independent of the fuel supply section 42 and the fuel receiving section 41. When the fuel supply section 42 and the fuel receiving section 41 are laminated to integrate the both, the passage 43 may be a passage connecting the both for the liquid fuel F. Namely, it is only necessary that the fuel supply section 42 be communicated with the fuel receiving section 41 through the passage 43 and the like.

The liquid fuel F received in the fuel receiving section 41 can be fed to the fuel supply section 42 by allowing the fuel to fall through the passage 43 by utilizing gravitation. Also, a porous body may be filled in the passage 43 to feed the liquid fuel F received in the fuel receiving section 41 to the fuel supply section 42 by the capillary phenomenon. Moreover, a pump may be provided in a part of the passage 43 to forcibly feed the liquid fuel F received in the fuel receiving section 41 to the fuel supply section 42.

The fuel distribution layer 30 is constituted of, for example, a plane plate formed with plural openings 31 and interposed between the anode gas diffusion layer 12 and the fuel supply section 42. This fuel distribution layer 30 is constituted of a material which does not transmit the liquid fuel F or gasified components of the liquid fuel F, and is specifically constituted of, for example, polyethylene terephthalate (PET) resin, polyethylene naphthalate (PEN) resin or polyimide-based resin.

Also, the fuel distribution layer 30 may be constituted of, for example, a gas-liquid separating film which separates gasified components of the liquid fuel F from the liquid fuel F to transmit the gasified components to the membrane electrode assembly 10 side. As the gas-liquid separating film, silicone rubber, low-density polyethylene (LDPE) thin film, polyvinyl chloride (PVC) thin film, polyethylene terephthalate (PET) thin film, fluororesin (for example, polytetrafluoroethylene (PTFE) or tetrafluoroethylene/perfluoroalkyl vinyl ether copolymer (PFA)) microporous film or the like is used.

### EXAMPLES

Fuel cells according to examples of the present invention will be explained with reference to the drawings. It is to be noted that in the following explanation, the same structures as those of the fuel cell according to the aforementioned embodiment are denoted by the same symbols and the explanation of these structures is omitted.

### First Example

A membrane electrode assembly 10 of a fuel cell according to First Example will be explained. Specifically, a perfluorocarbonsulfonic acid solution used as a proton conductive resin, and water and methoxypropanol used as dispersants were added to carbon black carrying anode catalyst particles (Pt:Ru=1:1) to disperse the carbon black carrying anode catalyst particles, thereby preparing a paste.

The paste obtained in the above manner was applied to porous carbon paper (rectangular shape of 40 mm×30 mm) used as the anode gas diffusion layer 12 to thereby form an anode catalyst layer 11 having a thickness of 100 μm.

The ratio by weight of a proton conductive resin in this anode catalyst layer 11 was 30% by weight and the area swelling rate given by the following formula when the anode catalyst layer 11 was dipped in pure water was 3%.

(Area swelling rate)(%)=((Area after dipping in pure water)−(Area before dipping in pure water))/(Area before dipping in pure water)

The porous carbon paper used as the anode gas diffusion layer 12 had a thickness of 370 μm, a flexural strength of 40 MPa and a bending elastic modulus of 10 GPa.

A perfluorocarbonsulfonic acid solution used as a proton conductive resin, and water and methoxypropanol used as dispersants were added to carbon black carrying cathode catalyst particles (Pt) to disperse the carbon black carrying cathode catalyst particles, thereby preparing a paste.

The paste obtained in the above manner was applied to porous carbon paper used as the cathode gas diffusion layer 14 to thereby form a cathode catalyst layer 13 having a thickness of 100 μm. The ratio by weight of a proton conductive resin in this cathode catalyst layer 13 was 30% by weight and the area swelling rate when the cathode catalyst layer 13 was dipped in pure water was 3%.

In this case, the anode gas diffusion layer 12 and the cathode gas diffusion layer 14 have the same shape, size and thickness, and the anode catalyst layer 11 and the cathode catalyst layer 13 which have been applied to these gas diffusion layers have the same shape and size.

A perfluorocarbonsulfonic acid film (trade name: Nafion film, manufactured by Du Pont) having a thickness of 30 μm and a moisture content of 10 to 20% by weight was interposed as the electrolyte membrane 15 between the anode catalyst layer 11 and the cathode catalyst layer 13 manufactured in the above manner. The resulting product was subjected to hot pressing performed under a pressure of 3 MPa under the condition that the anode catalyst layer 11 and the cathode catalyst layer 13 were positioned to be opposite to each other to thereby form a membrane electrode assembly 10.

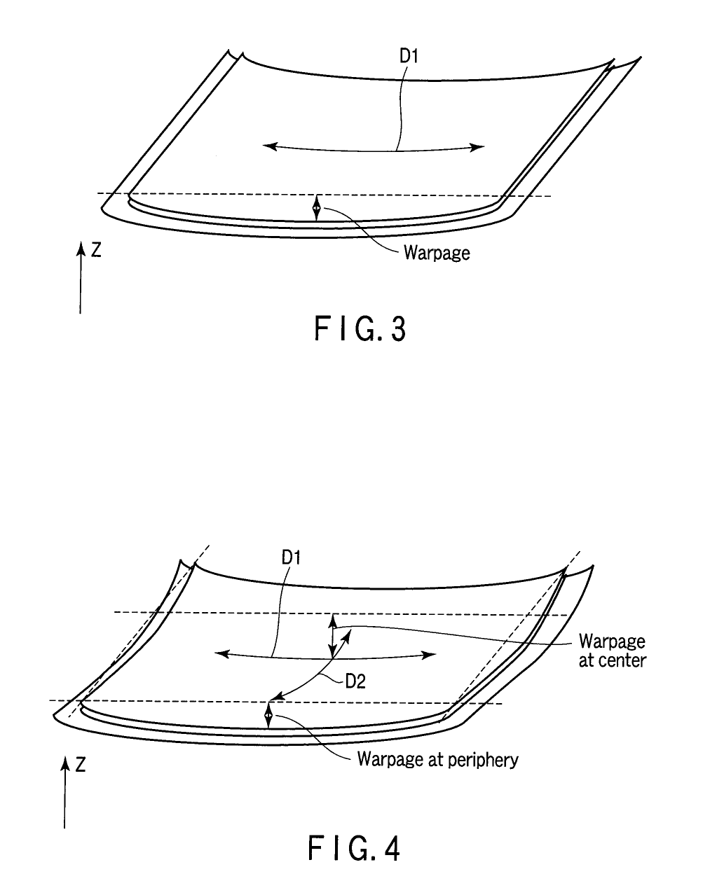

When this hot pressing was carried out, a press metal mold which was in contact with the anode side was made to have a single concave surface having a radius of curvature of 101 mm and a press metal mold which was in contact with the cathode side was made to have a single convex surface having a radius of curvature of 101 mm to thereby form the membrane electrode assembly 10 having a shape warped in a direction almost parallel to the long side in the plane direction of the membrane electrode assembly 10 and also in a direction D1 formed convexly toward the anode side as shown in FIG. 3. The longitudinal warpage in the center of the membrane electrode assembly 10 was 2 mm.

Here, the longitudinal warpage in the center of the membrane electrode assembly 10 means, as shown in FIG. 2, a distance, in a direction of the thickness (Z), between the center of the membrane electrode assembly 10 in its longitudinal direction and a part whose position is most changed in the direction of the thickness (direction of Z) of the membrane electrode assembly 10 along with the warpage of the membrane electrode assembly 10.

The fuel cell according to this example has the same structure as the fuel cell according to the above embodiment except for the above membrane electrode assembly 10.

Methanol having a purity of 99.9% by weight was supplied to the fuel cell comprising the membrane electrode assembly 10 formed in the above manner under an environment of a temperature of 25° C. and a relative humidity of 50%. Also, a constant voltage power source was connected to the fuel cell and the current through the fuel cell was controlled such that the output voltage of the fuel cell was fixed to 0.3 V to measure the output density obtained from the fuel cell at this time.

Here, the output density (mW/cm²) of the fuel cell means a value obtained by multiplying the current density (current per cm² [mA/cm²] of the generating section) in the fuel cell by the output voltage of the fuel cell.

Also, the area of the generating section means the area of the part where the anode catalyst layer 11 is disposed opposite to the cathode catalyst layer 13. In this example, the area of the generating section is the same as that of each of these catalyst layers 11 and 13 because the anode catalyst layer 11 has the same area as the cathode catalyst layer 13 and also, the both layers are made to entirely face each other.

Also, an AC impedance measuring device operated on a frequency of 1 kHz is connected to the fuel cell put in a generating state to measure the impedance of the fuel cell.

### Second Example

A fuel cell according to Second Example of the present invention will be explained. It is to be noted that in the following explanation, the same structures as those of the aforementioned fuel cell of First Example are denoted by the same symbols and the explanation of these structures is omitted.

A perfluorocarbonsulfonic acid solution used as a proton conductive resin, and water and methoxypropanol used as dispersants were added to carbon black carrying anode catalyst particles (Pt:Ru=1:1) to disperse the carbon black carrying anode catalyst particles, thereby preparing a paste. The paste obtained in the above manner was applied to porous carbon paper (rectangular shape of 40 mm×30 mm) used as the anode gas diffusion layer 12 to thereby form an anode catalyst layer 11 having a thickness of 100 μm.

The ratio by weight of a proton conductive resin in this anode catalyst layer 11 was 50% by weight and the area swelling rate given by the aforementioned formula when the anode catalyst layer 11 was dipped in pure water was 10%.

A perfluorocarbonsulfonic acid solution used as a proton conductive resin, and water and methoxypropanol used as dispersants were added to carbon black carrying cathode catalyst particles (Pt) to disperse the carbon black carrying cathode catalyst particles, thereby preparing a paste. The paste obtained in the above manner was applied to porous carbon paper used as the cathode gas diffusion layer 14 to thereby form a cathode catalyst layer 13 having a thickness of 100 μm.

The ratio by weight of a proton conductive resin in this cathode catalyst layer 13 was 10% by weight and the area swelling rate when the cathode catalyst layer 13 was dipped in pure water was 1%.

The anode catalyst layer 11 and the cathode catalyst layer 13 which were formed in this manner and the electrolyte membrane 15 were subjected to hot pressing using a press metal mold having a planar shape on both anode and cathode sides in the same manner as in First Example except that the metal mold having a planar shape was used, to form a membrane electrode assembly 10.

This membrane electrode assembly 10 had a planar shape just after the hot pressing was finished. However, when the membrane electrode assembly 10 was dipped in pure water, it was warped in the directions D1 and D2 as shown in FIG. 4. Specifically, as shown in FIG. 4, the membrane electrode assembly 10 has a shape warped toward the directions D1 and D2 which are directions almost parallel to the short side direction and long side direction in its plane direction and are also directions in which the center part of the membrane electrode assembly 10 is formed convexly toward the anode side.

The warpage of the center part shown in FIG. 4 was 3 mm and the warpage of the periphery was 2 mm. The reason why the membrane electrode assembly is warped like this is considered to be that the anode catalyst layer 11 is more largely swollen by a difference in area swelling rate between the anode catalyst layer 11 and the cathode catalyst layer 13 as mentioned above.

It is considered that when the fuel cell is in generating state, water is produced by the generating reaction in the cathode catalyst layer 13 of the membrane electrode assembly 10 and is then diffused to the electrolyte membrane 15 and to the anode catalyst layer 11, with the result that the whole of the membrane electrode assembly 10 is filled with water. Therefore, the condition of the membrane electrode assembly 10 dipped in pure water may be considered to simulate the condition of the membrane electrode assembly 10 in which the generating reaction is run.

The membrane electrode assembly 10 formed in this manner was fabricated in the same manner as in the case of the fuel cell of First Example to make a fuel cell. The output density of the fuel cell of Second Example was 105% based on the output density of the fuel cell according to First Example.

The AC impedance of the fuel cell during generating operation was measured and as a result, the AC impedance of the fuel cell according to Second Example was 90% of that of the fuel cell according to First Example.

### Comparative Example

A fuel cell according to Comparative Example in the present invention will be explained. The fuel cell according to this Comparative Example was manufactured in the same manner as in First Example except that the press metal mold used in the hot pressing in the process of forming the membrane electrode assembly 10 had a planar shape on both the anode and cathode sides. This membrane electrode assembly 10 had a planar shape just after the hot pressing was finished and when it was dipped in pure water.

The output density of the fuel cell according to this Comparative Example was 90% of that of the fuel cell according to First Example.

Also, the AC impedance of the fuel cell during generating operation was measured and as a result, the AC impedance of the fuel cell according to this Comparative Example was 110% of that of the fuel cell according to First Example.

The AC impedance measured in First Example, Second Example and Comparative Example is a value including the electric resistance of the anode conductive layer 13 and the cathode conductive layer 17 themselves, contact resistance between the anode conductive layer 13 and the terminal of an AC impedance measuring device, contact resistance between the cathode conductive layer 17 and the terminal of the AC impedance measuring device and ion conductive resistance of the electrolyte membrane in the membrane electrode assembly 10 besides the contact resistance between the membrane electrode assembly 10 and the anode conductive layer 13 and contact resistance between the membrane electrode assembly 10 and the cathode conductive layer 17.

However, if the size of the fuel cell, the material properties, thickness and size of the anode conductive layer 16 and the cathode conductive layer 17, the material properties, thickness and size of the electrolyte membrane 15 and the above generating condition are respectively the same, it is considered that components other than the contact resistances between the membrane electrode assembly 10 and the anode conductive layer 16 and between the membrane electrode assembly 10 and the cathode conductive layer 17 are respectively the same.

For this reason, it is considered that the magnitude of the AC impedance measured here indicates the magnitude of the contact resistances between the membrane electrode assembly 10 and the anode conductive layer 16 and between the membrane electrode assembly 10 and the cathode conductive layer 17.

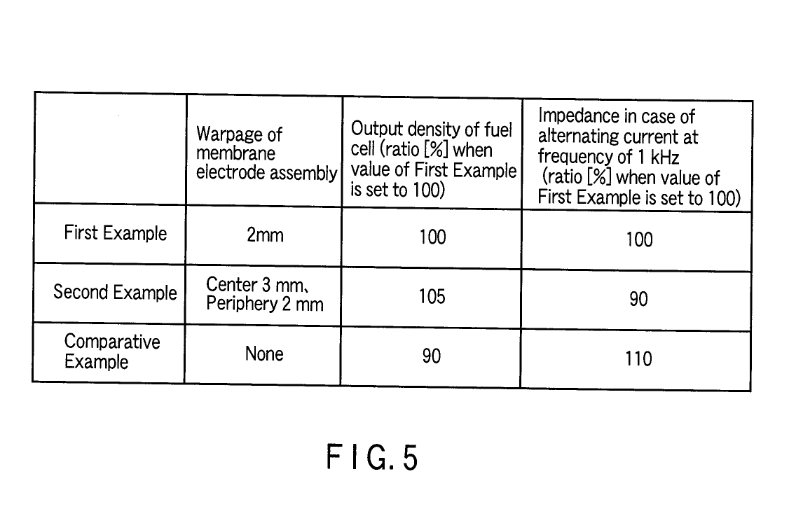

As shown in FIG. 5, it is found from the above results that a higher output than that from the fuel cell according to Comparative Example can be obtained from the fuel cells according to First Example and Second Example. Also, the fuel cells according to First Example and Second Example are more reduced in AC impedance when generating electricity than the fuel cell according to Comparative Example. Specifically, in the fuel cells of First Example and Second Example, the contacts between the membrane electrode assembly 10 and the anode conductive layer 11 and between the membrane electrode assembly 10 and the cathode conductive layer 13 can be well kept.

Specifically, the fuel cell according to this embodiment ensures that a fuel cell can be provided which well keeps the contacts between the membrane electrode assembly 10 and the anode conductive layer 11 and between the membrane electrode assembly 10 and the cathode conductive layer 13 and produces a high output.

The present invention is not limited to the above embodiment and may be embodied by modifying the structural elements without departing from the spirit of the invention. For example, the membrane electrode assembly 10 may have a warped shape formed convexly toward the cathode side though, in the above embodiment, the membrane electrode assembly 10 has a warped shape formed convexly toward the anode side. Even in such a case, the same effects as in the case of the fuel cell of the above embodiment can be obtained.

Also, various inventions can be made by proper combinations of plural structural elements disclosed in the above embodiment. For example, several structural elements may be excluded from all structural elements shown in the embodiment. Moreover, the structural elements in different embodiments may be appropriately combined.

The present invention can provide a fuel cell which well keeps the contact between the membrane electrode assembly and the conductive layers and produces a high output.

What is claimed is:

1. A fuel cell comprising:
a membrane electrode assembly comprising an anode, a cathode and an electrolyte membrane interposed between the anode and the cathode;
an anode conductive layer which is in contact with the anode;
a cathode conductive layer which is in contact with the cathode; and
a fuel supply mechanism which is disposed on the anode side of the membrane electrode assembly to supply fuel to the anode,
wherein the membrane electrode assembly comprises a shape formed convexly toward the anode side in a separate condition.

2. The fuel cell according to claim 1, wherein the anode comprises a higher swelling rate than the cathode.

3. The fuel cell according to claim 1, wherein the anode comprises a higher thermal expansion coefficient than the cathode.

4. A method of producing a fuel cell, comprising at least:
forming an anode;
forming a cathode;
forming an electrolyte membrane;
binding at least two or more of the anode, the cathode and the electrolyte membrane to form a membrane electrode assembly; and
incorporating the membrane electrode assembly into a fuel cell comprising an anode conductive layer which is in contact with the anode, a cathode conductive layer which is in contact with the cathode and a fuel supply mechanism which is disposed on the anode side of the membrane electrode assembly to supply fuel to the anode,
wherein the binding comprises pressing the membrane electrode assembly into a shape formed convexly toward the anode side.

5. A fuel cell comprising:
a membrane electrode assembly comprising an anode, a cathode and an electrolyte membrane interposed between the anode and the cathode;
an anode conductive layer which is in contact with the anode;
a cathode conductive layer which is in contact with the cathode; and
a fuel supply mechanism which is disposed on the anode side of the membrane electrode assembly to supply fuel to the anode,
wherein the membrane electrode assembly comprises a shape formed convexly toward the cathode side in a separate condition.

6. A method of producing a fuel cell, comprising at least:
forming an anode;
forming a cathode;
forming an electrolyte membrane;
binding at least two or more of the anode, the cathode and the electrolyte membrane to form a membrane electrode assembly; and
incorporating the membrane electrode assembly into a fuel cell comprising an anode conductive layer which is in contact with the anode, a cathode conductive layer which is in contact with the cathode and a fuel supply mechanism which is disposed on the anode side of the membrane electrode assembly to supply fuel to the anode,
wherein the binding comprises pressing the membrane electrode assembly into a shape formed convexly toward the cathode side.
